(19) United States
(12) Patent Application Publication
(10) Pub. No.: US 2021/0046978 A1
(43) Pub. Date: Feb. 18, 2021

(54) VEHICLE, VEHICLE CHASSIS AND DRIVETRAIN MODULE

(71) Applicant: ARRIVAL LIMITED, Oxfordshire (GB)

(72) Inventors: Gregory FOROSTOVSKY, Oxfordshire (GB); Stewart MORLEY, Oxfordshire (GB); Denis SVERTLOV, Oxfordshire (GB)

(21) Appl. No.: 16/963,550

(22) PCT Filed: Aug. 24, 2018
(86) PCT No.: PCT/GB2018/052415

§ 371 Date: Jul. 21, 2020

(30) Foreign Application Priority Data
Aug. 25, 2017 (GB) 1713720.9

(51) Int. Cl. B62D 21/04; B60K 1/00; B60G 7/00; B60K 1/04; B60L 50/60; B60K 17/00; H02K 7/00; H02K 7/116; H02K 11/00

(52) U.S. Cl. CPC B62D 21/04; B60K 1/00; B60G 7/001; B60K 1/04; B60G 2204/143; B60K 17/00; H02K 7/006; H02K 7/116; H02K 11/0094; B60L 50/66

(57) ABSTRACT

A low-profile vehicle chassis comprising at least one chassis section comprising an upper side, a lower side spaced from the upper side and a cavity defined between the upper and lower sides of the chassis. At least one drivetrain and/or power component of the vehicle is contained within the cavity. Also, a vehicle comprising such a chassis. Also provided is a drivetrain module for an electric vehicle, the drivetrain module comprising a housing, at least one electric motor within the housing, a gearbox within the housing and having an input connected to the at least one electric motor to receive drive from the at least one electric motor, and at least one drive shaft connected to an output of the gearbox to transmit mechanical drive from the gearbox.

### TECHNICAL FIELD

The present invention relates to a vehicle chassis, a vehicle and a drivetrain module and, in particular, to such aspects for use in an electric vehicle.

### BACKGROUND

The drive for more fuel efficient and environmentally friendly transport solutions is seeing an increasing level of development in the field of electric vehicles. Such vehicles include not only passenger vehicles for personal transport, but also commercial vehicles such as buses and trucks. Such electric vehicles (EVs) include pure battery electric vehicles (BEVs) powered by batteries alone, and range extender electric vehicles (REEVs) which also include an additional power source, such as a small internal combustion engine (ICE) connected to an electrical generator, to generate electricity to charge the battery and/or to supplement the battery power source. All such EVs include battery packs for supplying electrical power to the electric drive motor(s). Such battery packs typically comprise a number of connected battery modules contained within a battery box.

An obstacle in the rise in popularity and adoption of electric vehicles can be vehicle cost, which may arise through various factors, including complexity of construction and manufacture of such vehicles, and the manufacturing and assembly complexities of production of different vehicle configurations. It is also desirable to provide such vehicles with increased ease of use, practicality and flexibility. It is therefore desirable to seek to provide a chassis for a vehicle, particularly an electric vehicle, which may help towards alleviating or overcoming one or more of the problems mentioned above.

### SUMMARY

In accordance with embodiments of the invention, there is provided a low-profile vehicle chassis comprising at least one chassis section comprising an upper side, a lower side spaced from the upper side, a cavity defined between the upper and lower sides of the chassis, and at least one drivetrain and/or power component of the vehicle contained within the cavity.

The vehicle chassis may comprise a plurality of chassis sections, at least two of the chassis sections comprising an upper side, a lower side spaced from the upper side and a cavity defined between the upper and lower sides.

The or each chassis section may comprise a closed housing. The lower side may comprise an underbody floor of the vehicle chassis. The upper side may comprise a load-bearing upper floor of the vehicle chassis.

The at least one chassis section may include support formations within the cavity configured to receive and retain one or more drivetrain components of the vehicle. The support formations may be configured to receive a self-contained drivetrain module comprising an electric motor and a gear box contained within a housing.

The vehicle chassis may comprise a self-contained drivetrain module comprising an electric motor and a gear box contained within a housing, mounted within the cavity.

The drivetrain module may comprise an inverter, and/or may include two motors, and/or may include two half shafts. The drivetrain module may further comprise a suspension unit configured to support one or more vehicle wheels.

The vehicle chassis may comprise two self-contained drivetrain modules, each comprising an electric motor and a gear box, a first drivetrain module mounted within a cavity in a forward section of the chassis, and a second drivetrain module mounted within a cavity in a rear section of the chassis.

The support formations may be configured to receive and retain an electric motor mounted directly onto the support formations.

The vehicle chassis may comprise an electric motor mounted within the cavity directly onto the support formations.

The support formations may be configured to receive and retain a gearbox mounted directly onto the support formations. The vehicle chassis may comprise a gearbox mounted within the cavity directly onto the support formations.

The support formations may be configured to receive and retain a rotor and a stator of an electric motor mounted directly onto the support formations.

The vehicle chassis may comprise a stator and a rotor of an electric motor mounted within the cavity directly onto the support formations such that the chassis section comprises a housing of the motor.

The support formations may be configured to receive and retain gears and gear-supporting shafts mounted directly onto the support formations. The vehicle chassis may comprise gears and gear-supporting shafts mounted within the cavity directly onto the support formations such that the chassis section comprises a gearbox housing.

The vehicle chassis may comprise a plurality of wheels mounted to the chassis, and the upper side of the chassis may be lower than the top of the wheels over a majority of the length of the chassis. The upper side of the chassis may be lower than the top of the wheels over the entire length of the chassis.

The upper side of the chassis may be substantially flat over a majority of the length of the chassis. The upper side of the chassis may be substantially flat over the entire length of the chassis.

One or more longitudinal chassis rails may extend along a majority of the length of chassis and between the upper and lower sides. The chassis may comprise two spaced and parallel longitudinal chassis rails.

The vehicle chassis may comprise a suspension unit having a plurality of suspension arms coupled to suspension control components to control movement of the suspension arms, and at least one of the suspension control components may be disposed within the cavity of the vehicle chassis.

The at least one suspension control component within the cavity of the vehicle chassis may be provided within at least one drivetrain module.

At least one of the chassis sections may contain a plurality of battery modules within the chassis section cavity. The chassis section containing the battery modules may comprise a central chassis section of a plurality of chassis sections. This may advantageously help toward centralised and balanced weight distribution of the chassis.

The vehicle chassis may comprise a pair of front wheels and a pair of rear wheels, and wherein the chassis section containing the battery modules may be disposed between the front and rear wheels.

At least one of the upper and lower side of the chassis may comprise a removable hatch section to enable access to the cavity.

The depth of the chassis, between the upper side and the lower side, may be less than 300 mm, and may be less than 250 mm, and may be less than 200 mm.

Also provided is a drivetrain module for an electric vehicle, the drivetrain module comprising a housing, at least one electric motor within the housing, a gearbox within the housing and having an input connected to the at least one electric motor to receive drive from the at least one electric motor, at least one drive shaft connected to an output of the gearbox to transmit mechanical drive from the gearbox.

The drivetrain module may comprise two electric motors.

The gear box may include two inputs, each input respectively connected to one of the electric motors.

The gearbox may comprise a plurality of gears mounted on support shafts, and the housing may comprise support formations to directly receive and support the gears and support shafts, such that the housing comprises a gearbox casing.

The housing may comprise support formations to receive and support the or each electric motor, and a rotor and a stator of the electric motor may be directly received and supported on the support formations such that the housing comprises the casing of the or each motor.

The drivetrain module may comprise two half-shafts, one extending from a respective output of the gearbox, and the housing may comprise support formations which receive and support the half-shafts.

The housing may be configured to define a number of internal compartments, and the or each motor may be received in a motor compartment, and wherein the gearbox may be received in a separate gearbox compartment.

The drivetrain module may further comprise a suspension unit configured to support at least one vehicle wheel.

The suspension unit may comprise at least one suspension component disposed within a suspension housing. The suspension housing may be formed integrally with, and part of, the drivetrain module housing. The suspension housing may be a separate housing to the drivetrain module housing. The suspension housing may be coupled to the drivetrain module housing.

The suspension unit may comprise at least one suspension arm extending from the suspension housing.

The vehicle chassis as defined above may comprise a drivetrain module as defined above.

The housing of the drivetrain module may be disposed within the chassis cavity between the upper and lower sides of the chassis.

Also provided is an electric vehicle comprising a vehicle chassis as defined above. The electric vehicle may comprise a lorry, truck or other commercial vehicle.

### BRIEF DESCRIPTION OF THE DRAWINGS

Embodiments of the present invention will now be described, by way of example only, with reference to the accompanying drawings, in which:

FIG. 1 shows a perspective view of an embodiment of a commercial vehicle chassis comprising a conventional vehicle chassis frame with drivetrain modules mounted thereto;

FIG. 2 shows a side view of a vehicle chassis according to a first embodiment of the invention;

FIG. 3 shows a plan view from above of the vehicle chassis of FIG. 2;

FIG. 4 shows a perspective view of the vehicle chassis of FIGS. 2 and 3 with a portion exploded showing high voltage battery modules within the chassis;

FIG. 5 shows perspective view of an electric vehicle included a chassis of FIGS. 2 to 4, with portions of the vehicle body shown in ghost lines and the vehicle power and drivetrain components shown;

FIG. 6 shows a side view of the electric vehicle shown in FIG. 5;

FIG. 7 shows a perspective view of the power and drivetrain components of the vehicle of FIGS. 5 and 6 as laid out in the chassis, with the chassis omitted from view;

FIG. 8 shows a drivetrain module of the vehicle of FIGS. 5 to 7.

### DETAILED DESCRIPTION

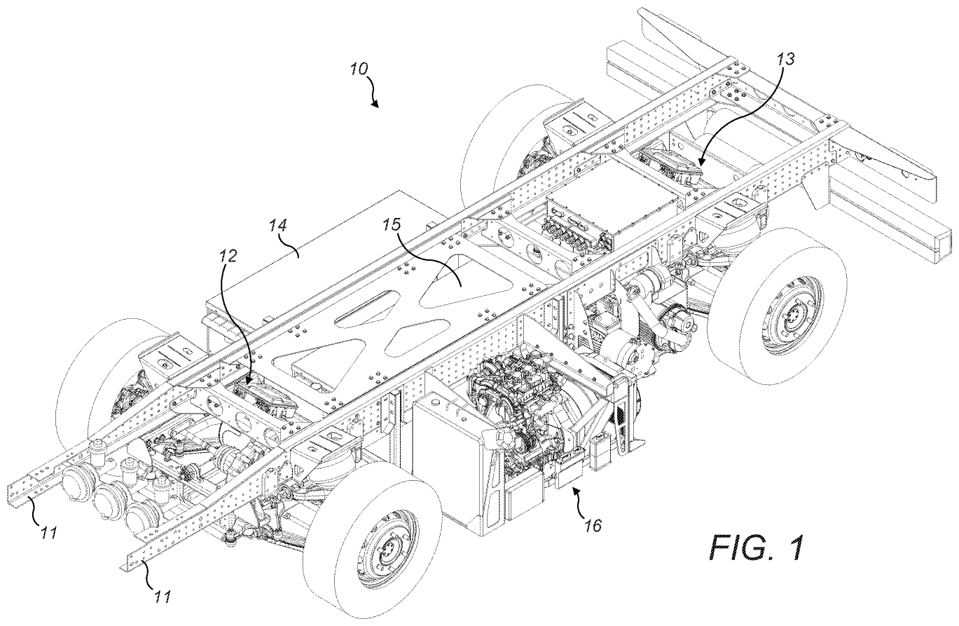

FIG. 1 shows a chassis 10 of a commercial REEV according to an embodiment of the applicant not within the scope of the present invention but shown for illustrative purposes only. The chassis 10 comprises a frame comprising a pair of parallel and spaced chassis rails 11, which is a conventional commercial vehicle chassis frame configuration. Various drivetrain modules and hardware are mounted to the chassis frame rails 11 to form a REEV chassis, including a front drivetrain module 12, a rear drivetrain module 13, battery packs 14, 15 and a range extender unit 16.

The configuration of REEV vehicle chassis shown in FIG. 1 has various advantages, one being that a REEV commercial vehicle can be manufactured in a modular fashion by mounting pre-assembled drivetrain sub-assemblies to a conventional chassis frame, and so existing commercial vehicle manufacturers can convert conventional commercial vehicles to be REEVs, or can manufacture REEVs with existing chassis frames and existing assembly facilities. However, it is alternatively desirable not to start a new REEV vehicle design from a conventional chassis frame, and instead to provide a new fundamental commercial vehicle chassis configuration to provide greater freedom and flexibility of design and manufacture.

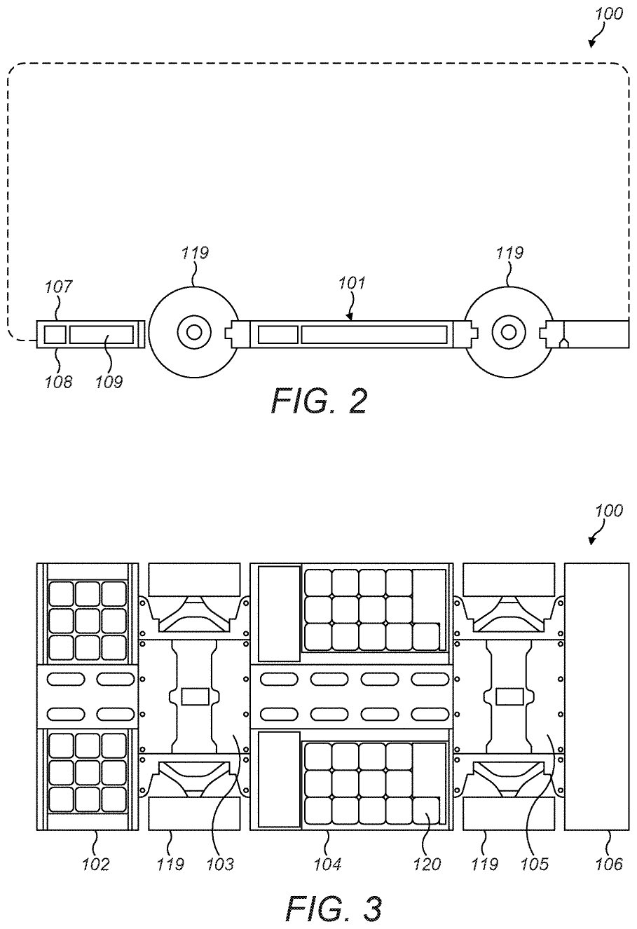

FIGS. 2 and 3 show a vehicle chassis 100 of a first embodiment of the invention. The chassis 100 has a chassis floor 101 which is of a low-profile and comprises a plurality of sections. The chassis sections include a front section 102, a front drivetrain section 103, a central section 104, a rear drivetrain section 105 and a rear section 106.

Each section may comprise a generally box-like structure having upper and lower sides, which may comprise upper and lower panels 107, 108 respectively. Hereinafter, for the exemplary embodiment of the invention described and illustrated, the upper and lower sides will be described as upper and lower panels 107, 108. The upper and lower panels 107, 108 are parallel and spaced apart to define a chassis cavity 109 in each chassis section. A depth ‘D’ of the chassis floor 101 may be defined as the distance between the top of the upper panel 107 and the bottom of the lower panel 108 of each chassis section (see FIG. 2). In one embodiment, the chassis floor depth D may be around 200 mm, and in another embodiment, the chassis floor depth D may be around 150 mm.

Advantageously, the chassis floor depth may be between 150 mm-400 mm, and may advantageously be between 150 mm-350 mm, and may advantageously be between 150 mm-300 mm, and may advantageously be between 150 mm-250 mm.

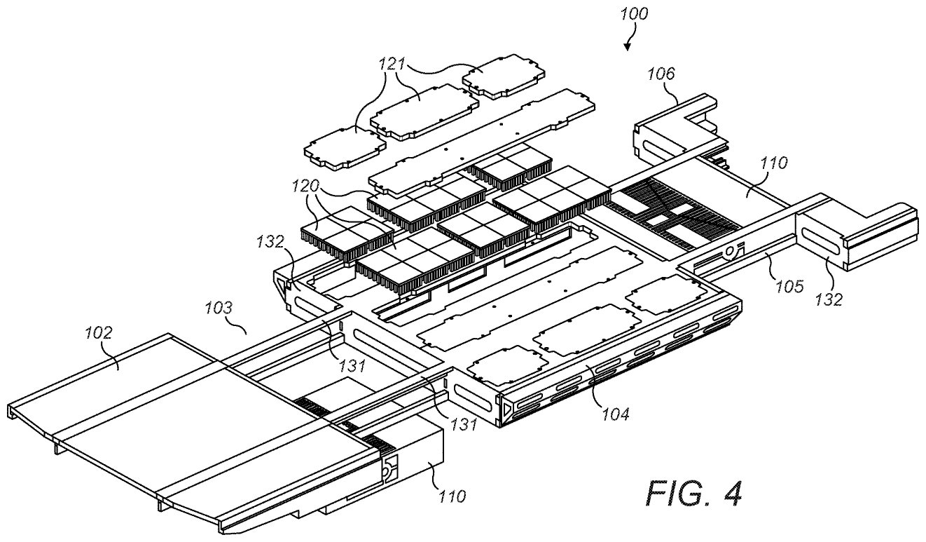

The chassis may comprise the various chassis sections 102-106 as separate box structures connected together with appropriate mechanical and/or chemical fastening means, such as bolts, rivets, bonding, etc. The chassis 100 may include one or more longitudinal structural strengthening rails 131. Such structural rail(s) may be provided in embodiments in which each chassis section is a separate box structure, or embodiments in which one or more of the chassis sections are integrally formed. Such structural rails 131 may extend along the majority of the length of the chassis 100, and may extend from the front section 102 to the rear section 106, through the front drivetrain section 103, central section 104 and a rear drivetrain section 105. The chassis 100 may include dividing walls 132 (see FIG. 4) separating the chassis cavities 109 of each chassis section from each other. Each of the chassis sections may comprise respective front and rear end walls 132 separating the chassis cavities 109 of each chassis section from each other. The dividing walls 132 may comprise ribs or spars extending between the upper and lower panels 107, 108 and which may provide structural strengthening to each chassis section.

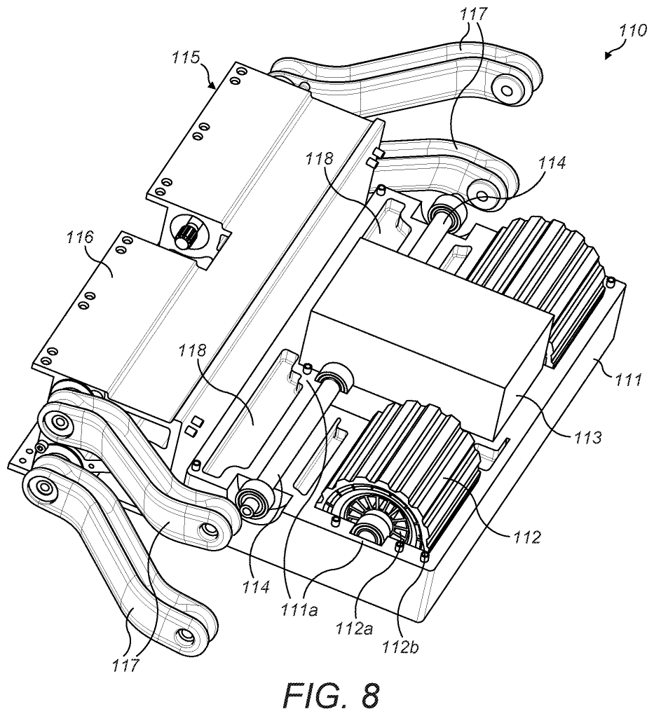

The front drivetrain section 103 includes a drivetrain module 110, shown in more detail in FIG. 8. Similarly, the rear drivetrain section 105 also includes a drivetrain module 110. The drivetrain module 110 comprises a housing 111 containing two electric motors 112 mechanically connected to inputs of a gearbox 113. An output of the gearbox 113 is mechanically connected to two half-shafts 114 extending out of opposite sides of the drivetrain module 110. The drivetrain module 110 also includes a suspension unit 115 comprising a suspension housing 116 and suspension arms 117 extending from the housing 116. Suspension components (not shown) which support the suspension arms 117 are provided within the suspension housing 116. As shown in FIG. 8, the suspension unit 115 may be provided as a contained module having its own suspension housing 116 separate to the drivetrain housing 111. The suspension housing 116 may be mechanically connected to the drivetrain housing 111. However, it is intended within the scope of the invention that the suspension housing 116 may be formed as part of, and integrally formed with, the drivetrain housing 111 so that only one housing is provided for the drivetrain module 110. In such an embodiment, the suspension components (not shown) would be provided within the one single housing 111 of the drivetrain module 110. Such suspension components may comprise one or more dampers, springs, support arms, and appropriate linkages. The drivetrain module 110 also includes two inverters 118 within the housing 111, each inverter 118 respectively electrically connected to one of the motors 112. The inverters 118 are configured to receive DC electrical power from one or more battery packs and to provide AC electrical power to the motors 112.

An advantage of the configuration of drivetrain module 110 described above is that a plurality of drivetrain components of the vehicle are contained as a single unit, within a single housing. For example, the motors 112, the gearbox 113, inverters 118 and half shafts 114 are provided within the housing 111. (In this context, the term “gearbox” is intended to mean the gears and support shafts of a motor gear system, without a dedicated casing or housing). This avoids the need for separate housings for each component and thereby reduces weight and material used. For example, there is no requirement for a separate gearbox casing, separate motor casing and separate inverter casing, and respective connectors and fixing points for each, as in conventional vehicle chassis design. In such conventional vehicle chassis design, there is a lot of component redundancy and multiple connecting components and fixing points required. Instead, in the chassis 100 of the present invention, the housing 111 is configured to accommodate the above-described drivetrain components in dedicated respective compartments within the housing 111, eliminating the need for multiple casings and fixings. The motor comprises a rotor 112a and a stator 112b, and the stator 112b may be fixedly mounted within a motor compartment of the housing 111. The rotor 112a may be rotatably mounted on support formations 111a formed on the body of the housing 111. Such a configuration is shown in FIG. 8. Likewise, one or more of each of the gearbox components 113, half-shafts 114 and suspension arms 117 may also be mounted on support formations 111a formed on the body of the housing 111.

Wheels 119 are supported on the suspension arms 117 and are rotatably driven by drive shafts (not shown) connected between each half shaft 114 and the respective wheel 119. The front wheels 119 are steerable by a steering mechanism for the vehicle. In some embodiments, the rear wheels 119 may also be steerable to enable the vehicle to have four-wheel steering. In such embodiments, the drivetrain module 100 may additionally comprise components of a steering mechanism (not shown), such as a steering actuator and one or more steering motors, to operate the steerable wheels 119. Additionally, the steering mechanism may comprise one or more steering rods, steering gears, a rack and pinion mechanism, and appropriate mechanical linkages, as well as associates sensors and associated electrical connections.

Each drivetrain module 110 is provided within the chassis cavity 109 of the respective drivetrain section 103, 105. The drivetrain module 110 is thereby configured to fit within the external dimensions of the chassis floor 101, between the upper and lower panels 107, 108 thereof. This provides a compact and low-profile, flat-floored chassis configuration. The provision of a flat chassis floor provides greater flexibility in vehicle design when designing the body and internal features of a vehicle as these do not need to be designed around awkward projecting elements of the chassis and drivetrain. This enables maximisation of the intended vehicle internal volume and flexibility of internal space design of the vehicle. Additionally, a low-profile chassis floor also enables a vehicle allowing greater ease of access, as there may be a reduced or eliminated need for steps for a driver and passengers to enter and exit the vehicle. This also makes loading a vehicle easier as, in the case of delivery trucks for example, the vehicle load bay entrance floor is at a low level. Yet further, a low-level and low-profile floor increases the internal volume within a vehicle for passengers or cargo.

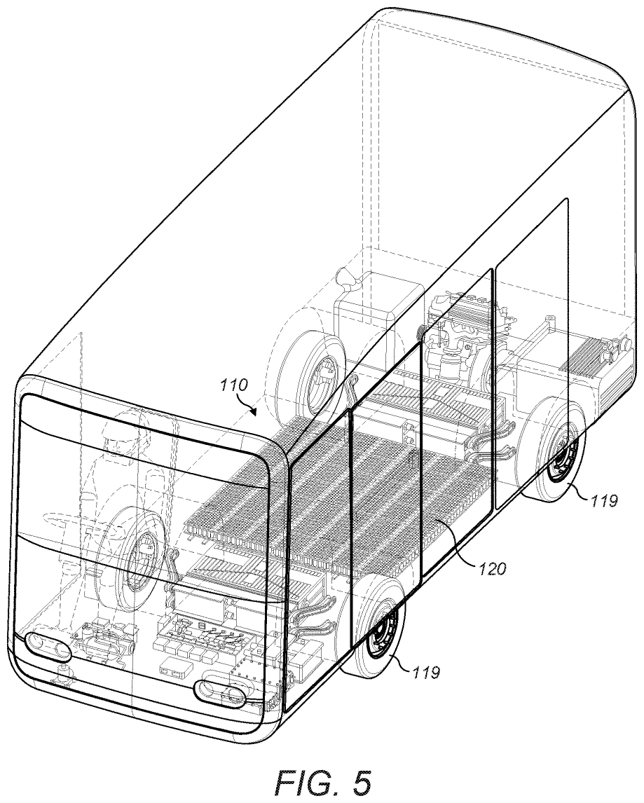

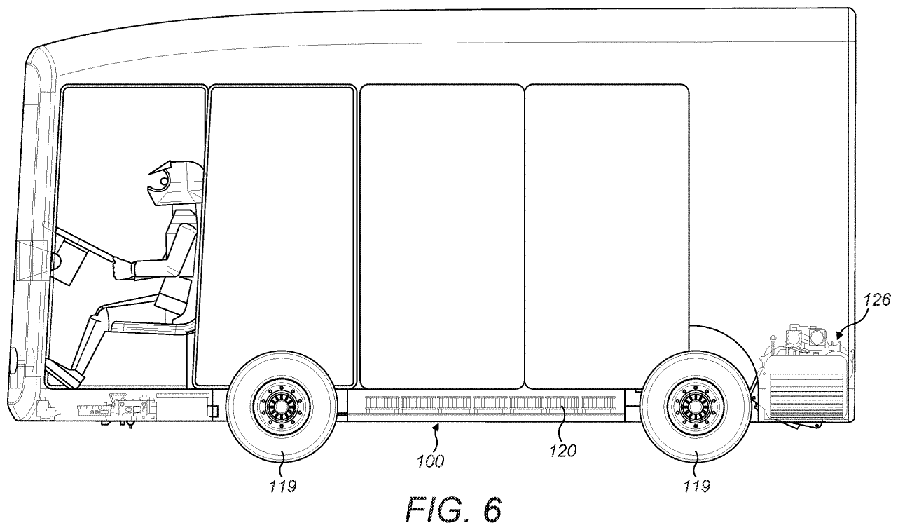

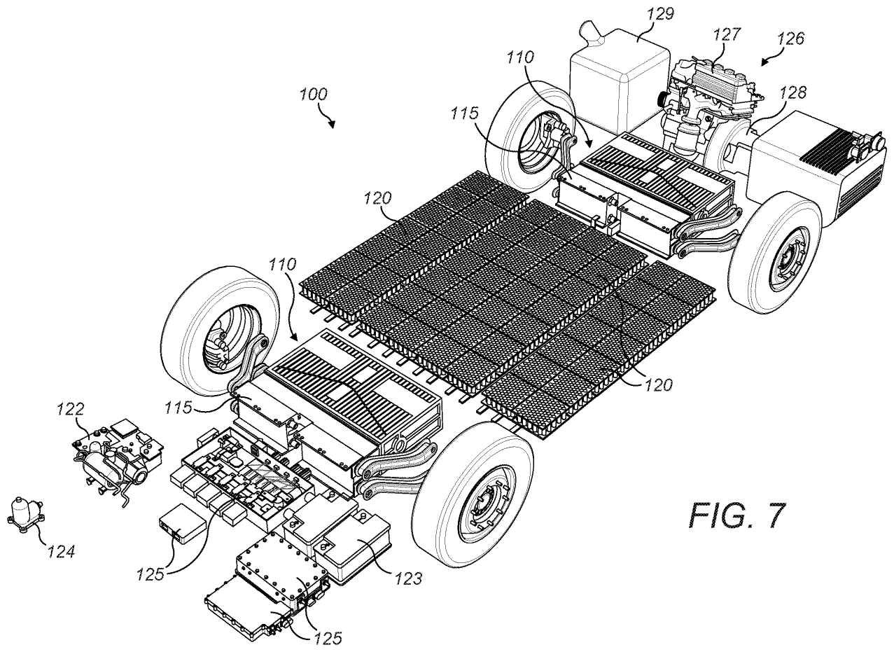

A number of battery modules 120 are provided within the chassis cavity 109 of the central section 104 of the chassis floor 101. These can be seen in FIG. 3 and also in FIGS. 5 and 6, and particularly FIG. 7. FIG. 7 shows the various components contained within the vehicle chassis 100 with the various chassis sections 102-106 omitted for clarity. As with the drivetrain modules 110, the battery modules 120 are configured to fit within the external dimensions of the chassis floor 101, between the upper and lower panels 107, 108 thereof, maintaining the compact and low-profile, flat-floored chassis configuration. The battery modules 120 are electrically connected to the inverters 118 of the drivetrain modules 110 via a high-voltage power distribution unit (“PDU”) (not shown). The upper panels 107 of the central section 104 may include one or more removable sections or hatches 121 to allow access to the battery modules 120 beneath the upper panel 107 for maintenance for example (see FIG. 4). The chassis cavity 109 of the central section 104 may also include a power distribution unit including a battery management system (not shown).

The front section 102 of the chassis floor 101 contains a number of electronic components for the vehicle control systems. Such components are provided within the chassis cavity 109 of the front section 102. These can be seen in FIG. 7, and they include a HVAC unit 122, low voltage batteries 123 for powering the electronic control system, a steering control system 124 and various system controllers and processors 125. All such components are contained within the external dimensions of the chassis floor 101, between the upper and lower panels 107, 108 thereof, maintaining the compact and low-profile, flat-floored chassis configuration.

The rear section 106 may be provided with various components of a range extender system 126 to provide supplemental electrical power to the battery modules 120 if needed. Such components may be provided mounted to the chassis floor 101, and therefore sit on or closely above the surface of the upper panel 107. Such range extender system 126 may comprise a range extender unit 127, for example a small-capacity internal combustion engine, and a generator mechanically coupled to, and configured to be driven by, the range extender unit 126. The generator 128 is electrically connected to the battery modules 120 via an inverter (not shown), or may be connected directly to one or both drivetrain modules no to provide electrical energy directly to the electric motors 112 via the inverters 117. The range extender system 126 also includes a fuel tank 129 and a RE cooling unit 130 configured to provide cooling to the range extender unit 127.

Some components of the RE system 126 may be disposed on the upper side of the chassis floor 101, and therefore project above the level of the upper side of the chassis floor 101. However, in an alternative embodiment, the range extender unit 127 may be made small enough to fit within the chassis cavity 109, together with the remaining components of the RE system 126. In such an embodiment, the range extender unit may be a single piston or rotary internal combustion engine. It will be appreciated that the upper side of the chassis floor 101 is substantially flat over the majority of the chassis length, and advantageously over the entire length of the chassis 100. Advantageously, the upper side of the chassis floor 101 is substantially flat in the region between the front and rear wheels, and may advantageously be flat from the rear wheels forwards to the front of the chassis. Yet further, the upper side of the chassis floor 101 may advantageously be flat from the front wheels rearwards to the rear of the chassis. Also, the upper side of the chassis floor 101 is disposed below the level of the top of the wheels 119 over the majority of the chassis length, and advantageously over the entire length of the chassis 100. Also, in an embodiment without a RE system, so as to be a pure EV, the chassis floor 101 may be flat over the entire chassis length, and maybe disposed below the level of the top of the wheels 119 over the entire chassis length, without any drivetrain components extending above the level of the chassis floor 101. The chassis floor 101 being disposed lower than the level of the top of the wheels 119 further enables a full vehicle body, including side flanks and wheel arches, to more easily be provided and mounted upon the flat chassis floor 101 with reduced chassis overhang and simplified chassis-to-body coupling. Yet further, the chassis floor 101 being disposed lower than the level of the top of the wheels 119 further provides the advantages of ease of personnel access and ease of loading and unloading, as well as increasing the internal volume of the vehicle, as described above.

Although an exemplary embodiment of the chassis 100 described above and illustrated in FIGS. 2-7 comprises both front and rear drivetrain modules no respectively disposed in the front and rear drivetrain sections 103, 105 so as to be four-wheel drive, the invention is not limited to this particular configuration. In an alternative configuration, the chassis 100 may only be two-wheel drive and may be either front-wheel drive or rear-wheel drive. Such two-wheel drive embodiments may comprise a drivetrain unit no in only the front drivetrain section 103 or in the rear drivetrain section 105. In such two-wheel drive embodiments, the non-driven wheels may be supported by means of a suspension unit 115 as described above disposed in the respective drivetrain section 103/105 but without the remaining drivetrain module components, or may be supported by means of a conventional vehicle suspension set-up.

Although the drivetrain module 110 is illustrated and described above as having two electric motors 112, the invention is not limited to this particular configuration. In an alternative configuration, the drivetrain module 110 may comprise only one electric motor. In such an embodiment, only one inverter 118 may be provided to provide AC electrical power to the one motor 112.

The exemplary embodiment of the chassis 100 described above and illustrated in FIGS. 2-7 comprises a drivetrain module 110 disposed within the chassis cavity 109 of the front, the rear, or both the front and the rear drivetrain sections 103, 105. Such drivetrain modules no as described above comprise various components of the drivetrain, and possibly suspension components, contained within a housing 111. However, the invention is not limited to this particular configuration comprising a drivetrain module housing 111 within the cavity 109 of the or each drivetrain chassis section 103, 105. In an alternative configuration, the front and/or rear drivetrain sections 103, 105 of the chassis 100 may be configured to accommodate and support the various drivetrain components without the need for the drivetrain module housing 11, and so a separate drivetrain unit housing 111 may be omitted. In such an embodiment, the front and/or rear drivetrain sections 103, 105 may comprise support formations (not shown) which may appropriately support, mount or otherwise retain the respective drivetrain components within the chassis cavity 109. For example, the motor stator 112b may be fixedly mounted on appropriate support formations formed within the chassis cavity 109 of the respective drivetrain section 103, 105 and the rotor 112a may be rotatably mounted on further appropriate support formations formed within the chassis cavity 109 of the respective drivetrain section 103, 105. Likewise, one or more of each of the gearbox components 113, half-shafts 114 and suspension arms 117 may also be mounted on support formations 111a formed within the chassis cavity 109 of the respective drivetrain section 103, 105.

It will be appreciated that in the above-described embodiments, the chassis 100 comprises a chassis floor 101 having an upper side upon which various further vehicle components may be mounted. Such components include, for example, a vehicle body, seating, user input controls such as steering mechanism and pedals, vehicle cab and related components such as dashboard and windscreen. As such, the upper side of the chassis floor 101 may comprise a load-bearing structural surface, and may comprise a plurality of mounting points for the attachment of any of the above-mentioned vehicle components.

It will be appreciated that in embodiments of the invention, the chassis floor 101 generally comprises a case or housing within which is contained a number of the drivetrain components of the chassis/vehicle, and are contained within the depth of the chassis floor 101.

The embodiments of the invention shown in the drawings and described above are exemplary embodiments only and are not intended to limit the scope of the invention, which is defined by the claims hereafter. It is intended that any combination of non-mutually exclusive features described herein are within the scope of the present invention.

1. A low-profile vehicle chassis comprising at least one chassis section comprising: an upper side;
a lower side spaced from the upper side;
a cavity defined between the upper and lower sides of the chassis; and
at least one component of the vehicle contained within the cavity.

2-5. (canceled)

6. A vehicle chassis according to claim 1 wherein the at least one chassis section includes support formations within the cavity configured to receive and retain one or more drivetrain components of the vehicle.

7. A vehicle chassis according to claim 6 wherein the support formations are configured to receive at least one of:
a self-contained drivetrain module comprising an electric motor and a gear box contained within a housing;
an electric motor mounted directly onto the support formations;
a gearbox mounted within the cavity directly onto the support formations;
a rotor and a stator of an electric motor mounted directly onto the support formations; and
gears and gear-supporting shafts mounted directly onto the support formations.

8-17. (canceled)

18. A vehicle chassis according to claim 1 comprising a plurality of wheels mounted to the chassis, and wherein the upper side of the chassis is lower than the top of the wheels over a majority of the length of the chassis.

19. A vehicle chassis according to claim 18 wherein the upper side of the chassis is lower than the top of the wheels over the entire length of the chassis.

20. A vehicle chassis according to claim 1 wherein the upper side of the chassis is substantially flat over a majority of or over an entirety of the length of the chassis.

21. (canceled)

22. A vehicle chassis according to claim 1 comprising one or more longitudinal chassis rails extending along a majority of the length of chassis and between the upper and lower sides.

23. (canceled)

24. A vehicle chassis according to claim 1, comprising a suspension unit having a plurality of suspension arms coupled to suspension control components to control movement of the suspension arms, wherein at least one of the suspension control components is disposed within the cavity of the vehicle chassis.

25. (canceled)

26. A vehicle chassis according to claim 1 wherein at least one of the chassis sections contains a plurality of battery modules within the chassis section cavity.

27. A vehicle chassis according to claim 26 wherein the chassis section containing the battery modules comprises a central chassis section of a plurality of chassis sections.

28. A vehicle chassis according to claim 26 wherein the vehicle chassis comprises a pair of front wheels and a pair of rear wheels, and wherein the chassis section containing the battery modules is disposed between the front and rear wheels.

29. A vehicle chassis according to claim 1 wherein at least one of the upper and lower side of the chassis comprises a removable hatch section to enable access to the cavity.

30-45. (canceled)

46. An electric vehicle comprising a low-profile vehicle chasis comprising at least one chassis section comprising:
an upper side;
a lower side spaced from the upper side;
a cavity defined between the upper and lower sides of the chassis; and at least one component of the vehicle contained within the cavity.

47. (canceled)

48. A vehicle chassis according to claim 26 wherein the battery modules are arranged to balance a distribution of weight within the chassis.

49. A vehicle chassis according to claim 26 wherein the battery modules are connected in an array.

50. A vehicle chassis according to claim 26 wherein the battery modules are connected in a rectilinear grid of modules.

51. A vehicle chassis according to claim 26 wherein the battery modules are connected in a rectilinear grid of modules selected from the set of 2×2, 2×3, 2×7, 2×8, 3×3, 3×4, 4×7 and 7×8, where the format means the number of battery modules running across the width of the chassis x the number of battery modules running down the length of the chassis.

52. A vehicle chassis according to claim 26 wherein each of the plurality of battery modules is configured to fit within dimensions of the vehicle chassis.

53. A vehicle chassis according to claim 26 wherein the battery modules are each substantially square when viewed top down.

54. A vehicle chassis according to claim 26 wherein the battery modules are each substantially square with truncated edges when viewed top down.

55. A vehicle chassis according to claim 1 comprising the chassis section when chemically fastened to different chassis sections, and where all of the chassis sections together present a substantially flat floor or surface.

56. A vehicle comprising according to claim 46 comprising the chassis section when chemically fastened to different chassis sections, and where all of the chassis sections together present a substantially flat floor or surface.

57. A battery pack for an electric vehicle, the battery pack comprising a plurality of battery modules, wherein each of the plurality of battery modules is configured to fit within dimensions of a chassis of the electric vehicle.

58. A battery pack according to claim 57 wherein the battery modules are each substantially square when viewed top down.

59. A battery pack according to claim 57 wherein the battery modules are each substantially square with truncated edges when viewed top down.

60. A battery pack according to claim 57 wherein the battery modules are connected in an array.

61. A battery pack according to claim 57 wherein the battery modules are connected in a rectilinear grid of modules.

62. A battery pack according to claim 57 wherein the battery modules are connected in a rectilinear grid of modules selected from the set of 2×2, 2×3, 2×7, 2×8, 3×3, 3×4, 4×7 and 7×8, where the format means the number of battery modules running across the width of the chassis x the number of battery modules running down the length of the chassis.
